(19) United States
(12) Patent Application Publication
(10) Pub. No.: US 2018/0010469 A1
(43) Pub. Date: Jan. 11, 2018

(54) TURBINE COMPONENT THERMAL BARRIER COATING WITH CRACK ISOLATING, CASCADING, MULTIFURCATED ENGINEERED GROOVE FEATURES

(71) Applicant: Siemens Aktiengesellschaft, München (DE)

(72) Inventors: Kai Kadau, Lake Wylie, SC (US); Jose Antonio Pascual-Gutierrez, Charlotte, NC (US); Atin Sharma, Charlotte, NC (US)

(21) Appl. No.: 15/547,655

(22) PCT Filed: Dec. 8, 2015
(86) PCT No.: PCT/US2015/064383

§ 371 Date: Jul. 31, 2017

Related U.S. Application Data
(63) Continuation of application No. PCT/US2015/016318, filed on Feb. 18, 2015.
Application No. PCT/US2015/016318 is a continuation of application No. PCT/US2015/016331, filed on Feb. 18, 2015.

(51) Int. Cl. F01D 5/28; F01D 5/14; F01D 11/12

(52) U.S. Cl. CPC F01D 5/288; F01D 11/122; F01D 5/147; F05D 2250/294; F05D 2250/132; F05D 2230/313; F05D 2230/312; F05D 2250/60; F05D 2300/502; F05D 2230/90

(57) ABSTRACT

Turbine engine (80) components, such as blades (92), vanes (104, 106), ring segment 110 abradable surfaces 120, or transitions (85), have furcated engineered groove features (EGFs) (403, 404, 418, 509, 511, 512) that cut into the outer surface of the component's thermal barrier coating (TBC). In some embodiments, the EGF planform pattern defines adjoining outer hexagons (560, 640, 670, 690, 710). In some embodiments, the EGF pattern further defines within each outer hexagon (560, 640, 670, 690, 710) a planform pattern of adjoining inner polygons (570, 580, 590, 600, 610, 680, 682, 700, 702, 704, 705, 720). At least three respective groove segments (509, 511, 512) within the EGF pattern (506, 507, 508) converge at each respective outer hexagonal vertex (510, 564) or inner polygonal vertex (574, 564, 604, 614) in a multifurcated pattern, so that crack-inducing stresses are attenuated in cascading fashion, as the stress (σ_{A}) is furcated (σ_{B}, σ_{C}) at each successive vertex juncture.

### PRIORITY CLAIM AND CROSS-REFERENCE TO RELATED APPLICATIONS

This application claims priority under the following International Patent Applications, the entire contents of each of which is incorporated by reference herein:

“TURBINE COMPONENT THERMAL BARRIER COATING WITH CRACK ISOLATING ENGINEERED GROOVE FEATURES”, filed Feb. 18, 2015, and assigned application number PCT/US2015/016318; and

“TURBINE COMPONENT THERMAL BARRIER COATING WITH CRACK ISOLATING ENGINEERED SURFACE FEATURES”, filed Feb. 18, 2015, and assigned application number PCT/US2015/016331.

A concurrently filed International Patent Application entitled “TURBINE COMPONENT THERMAL BARRIER COATING WITH VERTICALLY ALIGNED, ENGINEERED SURFACE AND MULTIFURCATED GROOVE FEATURES”, docket number 2015P22738WO, and assigned serial number (unknown) is identified as a related application and is incorporated by reference herein.

### TECHNICAL FIELD

The invention relates to combustion or steam turbine engines having thermal barrier coating (“TBC”) layers on its component surfaces, such as blades, vanes, ring segments, or transitions, which are exposed to heated working fluids, such as combustion gasses or high-pressure steam, including individual sub components that incorporate such thermal barrier coatings. The invention also relates to methods for reducing crack propagation or spallation damage to such component TBC layers that are often caused by engine thermal cycling or foreign object damage (“FOD”). More particularly, various embodiments described herein relate to the formation of planform patterns of engineered multifurcated groove features (“EGFs”) within the outer surface of the TBC, which define adjoining outer hexagons, and a planform pattern of adjoining inner polygons, and which respectively share at least a common inner polygonal vertex and are respectively fully circumscribed within its respective outer hexagon. At least three respective groove segments within the EGF pattern converge at each respective outer hexagonal or inner polygonal vertex in a multifurcated pattern, so that each converging groove segment has at least two other (i.e., bifurcated) adjoining converging groove segments. Stress induced crack propagation in the TBC is attenuated in cascading fashion as the stress is furcated at each successive vertex juncture. The cascading, furcated EGFs localize thermal stress or FOD induced crack propagation within the TBC that might otherwise allow excessive TBC spallation and subsequent thermal exposure damage to the turbine component underlying substrate.

### BACKGROUND

Known turbine engines, including gas/combustion turbine engines and steam turbine engines, incorporate shaft-mounted turbine blades circumferentially circumscribed by a turbine casing or housing. The remainder of this description focuses on applications within combustion or gas turbine technical application and environment, though exemplary embodiments described herein are applicable to steam turbine engines. In a gas/combustion turbine engine, hot combustion gasses flow in a combustion path that initiates within a combustor and are directed through a generally tubular transition into a turbine section. A forward or Row 1 vane directs the combustion gasses past successive alternating rows of turbine blades and vanes. Hot combustion gas striking the turbine blades cause blade rotation, thereby converting thermal energy within the hot gasses to mechanical work, which is available for powering rotating machinery, such as an electrical generator.

Engine internal components within the hot combustion gas path are exposed to combustion temperatures approximately well over 1000 degrees Celsius (1832 degrees Fahrenheit). The engine internal components within the combustion path, such as for example combustion section transitions, vanes and blades are often constructed of high temperature resistant superalloys. Blades and vanes often include cooling passages terminating in cooling holes on component outer surface, for passage of coolant fluid into the combustion path.

Turbine engine internal components often incorporate a thermal barrier coat or coating (“TBC”) of metal-ceramic material that is applied directly to the external surface of the component substrate surface or over an intermediate metallic bond coat (“BC”) that was previously applied to the substrate surface. The TBC provides a thermal insulating layer over the component substrate, which reduces the substrate temperature. Combination of TBC application along with cooling passages in the component further lowers the substrate temperature. In some applications, a multi-layer TBC is utilized, in which case the outermost TBC layer whose outside surface is exposed to the combustion gasses is referred to herein as the outer thermal barrier coating (“OTBC”). Both the terms TBC and OTBC are used interchangeably herein when referring to general material properties of the coatings proximate to the coating outer surface that contacts hot working gas in the engine. When referring to the outer surface that contacts hot working gas, it will be the outer surface of the TBC, in single layer embodiments, or correspondly, the outer surface of the OTBC in multi-layer embodiments.

Due to differences in thermal expansion, fracture toughness and elastic modulus,among other things, between typical metal-ceramic TBC materials and typical superalloy materials used to manufacture the aforementioned exemplary turbine components, there is potential risk of thermally- and/or mechanically-induced stress cracking of the TBC layer as well as TBC/turbine component adhesion loss at the interface of the dissimilar materials. The cracks and/or adhesion loss/delamination negatively affect the TBC layer's structural integrity and potentially lead to its spallation (i.e., separation of the TBC insulative material from the turbine component). For example, vertical cracks developing within the TBC layer can propagate to the TBC/substrate interface, and then spread horizontally. Similarly, horizontally oriented cracks can originate within the TBC layer or proximal the TBC/substrate interface. Such cracking loss of TBC structural integrity can lead to further, premature damage to the underlying component substrate. When the TBC layer breaks away from underlying substrate, the latter loses its protective thermal layer coating. During continued operation of the turbine engine, it is possible over time that the hot combustion gasses will erode or otherwise damage the exposed component substrate surface, potentially reducing engine operational service life. Potential spallation risk increases with successive powering on/off cycles as the engine is brought on line to generate electrical power in response to electric grid increased load demands and idling down as grid load demand decreases. In order to manage the TBC spallation risk and other engine operational maintenance needs, combustion turbine engines are often taken out of service for inspection and maintenance after a defined number of powering on/off thermal cycles.

In addition to thermal- or vibration-induced, stress crack susceptibility, the TBC layer on engine components is also susceptible to foreign object damage (“FOD”) as contaminant particles within the hot combustion gasses strike the relatively brittle TBC material. A foreign object impact can crack the TBC surface, ultimately causing spallation loss of surface integrity that is analogous to a road pothole. Once foreign object impact spalls off a portion of the TBC layer, the remaining TBC material is susceptible to structural crack propagation and/or further spalling of the insulative layer. In addition to environmental damage of the TBC layer by foreign objects, contaminants in the combustion gasses, such as calcium, magnesium, aluminum, and silicon (often referred to as “CMAS”) can adhere to or react with the TBC layer outer surface, increasing the probability of TBC spallation and exposing the underlying BC.

In order to enhance TBC layer structural integrity and affixation to turbine component underlying substrates, past attempts have included development of stronger TBC materials better able to resist thermal cracking or FOD, but with tradeoffs in reduced thermal resistivity or increased material cost. Generally, the relatively stronger, less brittle potential materials for TBC application have had lower thermal resistivity. Alternatively, as a compromise separately applied multiple layers of TBC materials having different advantageous properties have been applied to turbine component substrates,for example a more brittle or softer TBC material having better insulative properties that is in turn covered by a stronger, lower insulative value TBC material as a tougher “armor” outer coating better able to resist FOD and/or CMAS or other chemical contaminant adhesion. In order to improve TBC adhesion to the underlying substrate, intermediate metallic bond coat (BC) layers have been applied directly over the substrate. Structural surface properties and/or profile of the substrate or BC interface to the TBC have also been modified from a flat, bare surface. Some known substrate and/or BC surface modifications (e.g., so-called “rough bond coats” or RBCs) have included roughening the surface by ablation or other blasting, thermal spray deposit or the like. In some instances, the BC or substrate surface has been photoresist or laser etched to include surface features approximately a few microns (μm) in height and spacing width across the surface planform. Features have been formed directly on the substrate surface of turbine blade tips to mitigate stress experienced in blade tip coatings. Rough bond coats have been thermally sprayed to leave porous surfaces of a few micron-sized features. TBC layers have been applied by locally varying homogeneity of the applied ceramic-metallic material to create pre-weakened zones for attracting crack propagation in controlled directions. For example a weakened zone has been created in the TBC layer corresponding to a known or likely stress concentration zone, so that any cracks developing therein are propagated in a desired direction to minimize overall structural damage to the TBC layer.

### SUMMARY OF THE INVENTION

Various embodiments of turbine component construction and methods for making turbine components that are described herein help preserve turbine component thermal barrier coating (“TBC”) layer structural integrity during turbine engine operation. In some embodiments, engineered surface features (ESFs) formed directly in the component substrate or in, intermediate layers applied over the substrate enhance TBC layer adhesion thereto. In some embodiments, the ESFs function as walls or barriers that contain or isolate cracks in the TBC layer, inhibiting additional crack propagation within that layer or delamination from adjoining coupled layers. In some embodiments, the ESFs and vertices of converging EGFs are vertically aligned.

In some embodiments, engineered groove features (EGFs) are cut and formed in the TBC layer through the outer surface thereof, such as by laser, water jet, or machining, into a previously formed TBC layer. The EGFs functioning as the equivalent of a fire line that prevents a fire from spreading across a void or gap in combustible material—stop further crack propagation in the TBC layer across the groove to other zones in the TBC layer. EGFs in some embodiments are aligned with stress zones that are susceptible to development of cracks during engine operation. In such embodiments, formation of a groove in the stress zone removes material that possibly or likely will form a stress crack during engine operation. In other embodiments, EGFs are formed in convenient two dimensional or polygonal planform patterns into the TBC layer. The EGFs localize thermal stress or foreign object damage (FOD) induced crack propagation within the TBC that might otherwise allow excessive TBC spallation and subsequent thermal exposure damage to the turbine component underlying substrate. A given TBC surface area that has developed one or more stress cracks is isolated from non-cracked portions that are outside of the EGFs. Therefore, if the cracked portion isolated by one or more EGFs spalls from the component the remaining TBC surface outside the crack containing grooves will not spall off because of the contained crack(s).

In some embodiments, spallation of cracked TBC material that is constrained within ESFs and/or EGFs leaves a partial underlying TBC layer that is analogous to a road pothole. The underlying TBC material that forms the floor or base of the “pot hole” provides continuing thermal protection for the turbine engine component underlying substrate.

In some embodiments, the ESFs have planform patterns of multifurcated groove segments that converge in vertices. The multifurcated, groove geometry is useful for arresting crack propagation in the TBC, whether the crack inducing stress in the TBC is caused by thermo-mechanical stress, induced by heating transients, or foreign object damage (FOD) impact mechanical stress. Crack-inducing stress initiated within the boundaries of any single polygon bounded by the ESF grooves will either be dissipated by the TBC material volume within the circumscribing polygon (i.e., arrested therein), or the stress-induced crack in the TBC material will eventually intersect one or more of the groove segments in the circumscribing polygon's boundary, which converge with other downstream ESF groove segments at a commonly shared vertex. If the stress force is sufficiently high to propagate into the downstream, adjoining groove segments that share the common vertex, it will be furcated by some ratio, so that the resultant absolute stress level in each adjoining TBC material volume that is bounded by the respective downstream groove segments is lower than the absolute stress level in the upstream, stress force transferring TBC material. As stress concentration is sequentially multifurcated (or bifurcated, in the case of only two downstream groove segments in a trio of segments) in cascading fashion, spreading the stress in controlled fashion over a larger surface area of the turbine component's thermal barrier coating (TBC), it eventually reduces to a level that can be absorbed by the localized TBC layer.

More particularly, embodiments of the invention described herein feature. combustion turbine engine component, having a heat insulating outer surface for exposure to combustion gas, which in various embodiments is a blade, vane, transition, or ring segment abradable component. The component includes a metallic substrate having a substrate surface, with an anchoring layer built upon the substrate surface. The component also has a thermally sprayed or vapor deposited or solution/suspension plasma sprayed, single- or multi-layer thermal barrier coat (TBC) having a TBC inner surface applied over and coupled to the anchoring layer and an a TBC outer surface for exposure to combustion gas. A planform pattern of engineered groove features (EGFs), having groove depths, is cut and formed into the TBC outer surface, penetrating the previously applied TBC layer. The EGF pattern defines a planform pattern of adjoining outer hexagons, respectively having six hexagonal vertices, with each respective pair of adjoining outer hexagons sharing a common groove segment. The EGF pattern further defines within each outer hexagon a planform pattern of adjoining inner polygons. The adjoining inner polygons respectively share at least a common inner polygonal vertex and are respectively fully circumscribed within its respective outer hexagon. At least three respective groove segments within the EGF pattern converge at each respective outer hexagonal or inner polygonal vertex in a multifurcated pattern, so that each converging groove segment has at least two other adjoining converging groove segments.

Other embodiments of the invention described herein feature a method for controlling crack propagation in a thermal barrier coating (TBC) outer layer of an operating combustion turbine engine component having a heat insulating outer surface for exposure to combustion gas, such as a blade, vane, transition or ring segment abradable component. The method comprises providing a combustion turbine engine, the engine having a blade, vane, transition, or ring segment abradable component, having a metallic substrate having a substrate surface, and an anchoring layer built upon the substrate surface. A thermally sprayed or vapor deposited or solution/suspension plasma sprayed, single- or multi-layer thermal barrier coat (TBC) having a TBC inner surface is applied over and coupled to the anchoring layer. The TBC layer has a TBC outer surface for exposure to combustion gas. A planform pattern of engineered groove features (EGFs) is cut and formed into the TBC outer surface, penetrating the previously applied TBC layer. The EGFs have groove depths. The EGF pattern defines a planform pattern of adjoining outer hexagons respectively having six hexagonal vertices, with each respective pair of adjoining outer hexagons sharing a common groove segment. The EGF pattern further defines within each outer hexagon a planform pattern of adjoining inner polygons. The adjoining inner polygons respectively share at least a common inner polygonal vertex and are respectively fully circumscribed within a respective outer hexagon. At least three respective groove segments within the EGF pattern converge at each respective outer hexagonal or inner polygonal vertex in a multifurcated pattern, so that each converging groove segment has at least two other adjoining converging groove segments. The engine is operated, inducing thermal or mechanical stress in the TBC during engine thermal cycling, or inducing mechanical stress in the TBC by foreign object impact. When any of the induced stresses generates a crack in the TBC within one or more of the inner polygons, further crack propagation is arrested within one or more of successive inner polygons through which the crack propagates at its intersection with one or more of the groove segments defining the respective polygon. Alternatively, further crack propagation is arrested or upon its intersection with one or more of the groove segments defining an adjoining polygon or upon its intersection with one or more of the groove segments defining a circumscribing outer hexagon.

The respective features of the various embodiments described in the invention herein may be applied jointly or severally in any combination or sub-combination.

### BRIEF DESCRIPTION OF THE DRAWINGS

The embodiments shown and described herein can be understood by considering the following detailed description in conjunction with the accompanying drawings, in which:

FIG. 1 is a partial axial cross sectional view of a gas or combustion turbine engine incorporating one more exemplary thermal barrier coating (“TBC”) embodiments of the invention;

FIG. 2 is a detailed cross sectional elevational view of the turbine engine of FIG. 1, showing Row 1 turbine blade and Rows 1 and 2 vanes incorporating one or more exemplary TBC embodiments of the invention;

FIG. 3 is a fragmentary view of a turbine component, such as for example a turbine blade, vane or combustion section transition, having an exemplary embodiment of engineered surface features (“ESFs”) formed in a bond coat (“BC”) with the TBC applied over the ESFs;

FIG. 4 is a fragmentary view of a turbine component, having an exemplary embodiment of ESFs formed directly in the substrate surface with a two layer TBC comprising a lower thermal barrier coat (“LTBC”) applied over the ESFs and an outer thermal barrier coat (“OTBC”) applied over the LTBC;

FIG. 5 is a fragmentary view of an exemplary embodiment of a turbine component having hexagonal planform profile of solid projection ESFs on its substrate surface;

FIG. 6 is a cross section of the ESF of FIG. 5;

FIG. 7 is a fragmentary view of a turbine component having an exemplary embodiment of a plurality of cylindrical or post-like profile ESFs forming in combination a hexagonal planform pattern on its substrate surface that surround or circumscribes another centrally located post-like ESF;

FIG. 8 is a cross section of the ESF of FIG. 7;

FIG. 9 is a fragmentary view of a turbine component having an exemplary embodiment of a roughened bond coat (“RBC”) layer applied over previously formed ESF in a lower BC that was previously applied to the component substrate;

FIG. 10 is a fragmentary cross section of a prior art turbine component experiencing vertical and horizontal crack formation in a bi-layer TBC, having a featureless surface BC applied over a similarly featureless surface substrate;

FIG. 11 is a fragmentary cross section of a turbine component having an exemplary embodiment of ESFs formed in a LTBC layer, wherein vertical and horizontal crack propagation has been arrested and disrupted by the ESFs;

FIG. 12 is a fragmentary perspective view of a turbine component having an exemplary embodiment of engineered groove features (“EGFs”) formed in the TBC outer surface;

FIG. 13 is a schematic cross sectional view of the turbine component of FIG. 12 having EGFs formed in the TBC;

FIG. 14 is a schematic cross sectional view of the turbine component of FIG. 13 after impact by a foreign object, causing foreign object damage (“FOD”) in the TBC, where crack propagation has been arrested along intersections with the EGFs;

FIG. 15 is a schematic cross sectional view of the turbine component of FIG. 13 after spallation of an portion of the TBC above the cracks, leaving an intact layer of the TBC below the cracks for continuing thermal insulation of the underlying turbine component substrate;

FIG. 16 is a schematic cross sectional view of a turbine component having an exemplary embodiment of a trapezoidal cross section ESF that is anchoring the TBC, with the arrows pointing to stress concentration zones within the TBC;

FIG. 17 is a schematic cross sectional view of the turbine component of FIG. 16, in which exemplary embodiments of angled EGFs have been cut into the TBC in alignment with the stress concentration zones in order to mitigate potential stress concentration;

FIG. 18 is a schematic cross sectional view of an exemplary embodiment of a turbine component having both ESFs and EGFs;

FIG. 19 is a schematic cross sectional view of the turbine component of FIG. 18, in which FOD crack propagation has been constrained by the ESFs and EGFs;

FIG. 20 is an exemplary embodiment of EGFs formed in a turbine component TBC outer surface near component cooling holes, in order to arrest propagation of cracks or delamination of the TBC layer in zones surrounding the cooling holes to the surface area on the opposite sides of the grooves;

FIG. 21 is a schematic plan view of an exemplary embodiment of a turbine component outer surface OTBC layer, with furcated, EGFs forming hexagon planform patterns therein, with the formed grooves converging at vertices of the hexagons, wherein OTBC layer stress force in the OTBC material along one upstream groove that has induced crack propagation therein is bifurcated at a pair of downstream grooves, thereby arresting further crack propagation in the OTBC material;

FIG. 22 is an alternative embodiment of a turbine component outer surface OTBC layer, with furcated, EGFs forming a planform pattern of adjoining hexagons therein, with formed discontinuous grooves converging at a vertices of the hexagon;

FIG. 23 is a schematic planform view of an alternative embodiment of a turbine component outer surface OTBC layer, with furcated, EGFs forming varying size and density hexagonal planform patterns across the component surface;

FIG. 24 is a schematic planform view of an alternative embodiment of a turbine component outer surface OTBC layer, with furcated, EGFs forming adjoining outer hexagons, which in turn circumscribe furcated EGFs forming nested hexagons and triangular polygons;

FIG. 25 is a schematic planform view of an alternative embodiment of a turbine component outer surface OTBC layer, with furcated, EGFs forming an outer hexagon whose converging groove segment vertices are vertically aligned with ESFs projecting from the substrate, the outer hexagon in turn circumscribing furcated EGFs forming triangular polygons that converge at a central vertex over a central ESF;

FIG. 26 is a schematic planform view of an alternative embodiment of a turbine component outer surface OTBC layer, with furcated, EGFs forming an outer hexagon whose converging groove segment vertices are vertically aligned with ESFs, the outer hexagon in turn circumscribing furcated EGFs forming adjoining hexagons and trapezoid polygons;

FIG. 27 is a schematic planform view of an alternative embodiment of a turbine component outer surface OTBC layer, with furcated, EGFs forming an outer hexagon whose converging groove segment vertices are vertically aligned with ESFs, the outer hexagon in turn circumscribing furcated EGFs forming adjoining hexagons and triangle polygons of different sizes, including a central, nested hexagon vertically aligned with a central ESF; and

FIG. 28 is a schematic planform view of an alternative embodiment of a turbine component outer surface OTBC layer, with furcated, EGFs forming an outer hexagon whose converging groove segment vertices are vertically aligned with ESFs, and with other furcated, EGFs forming a grid of smaller hexagons.

To facilitate understanding, identical reference numerals have been used, where possible, to designate identical elements that are common to the figures. The figures are not drawn to scale. In any drawing, a reference number designation “XX/YY” refers to either of the elements “XX” or “YY”. The following common designators for dimensions, fluid flow, and turbine blade rotation have been utilized throughout the various invention embodiments described herein:
D_{G} groove depth;
F flow direction through turbine engine;
G turbine blade tip to abradable surface gap;
H_{R} ridge height;
R turbine blade rotational direction;
R₁ Row 1 of the turbine engine turbine section;
R₂ Row 2 of the turbine engine turbine section;
S_{R} ridge centerline spacing;
S_{G} groove spacing;
T thermal barrier coat (“TBC”) layer thickness;
W width of a surface feature;
W_{G} groove width; and
σ a stress concentration in a TBC.

### DESCRIPTION OF EMBODIMENTS

Exemplary embodiments of the present invention enhance performance of the thermal barrier coatings (“TBCs”) that are applied to surfaces of turbine engine components, including combustion or gas turbine engines, as well as steam turbine engines. In exemplary embodiments of the invention that are described in detail herein, engineered groove features (“EGFs”) are formed within the TBC, and more particularly in the outer surface of the TBC. In the case of multi-layer TBC applications, the EGFs are formed in the outer surface of the outer thermal barrier coating (“OTBC”), and selectively are cut to any desired depth, including down to the substrate surface. EGF widths are also selectively varied. The EGFs are formed in furcated planform patterns, meaning multiple grooves converge, or from another alternative relative perspective, diverge in a forked pattern from a common vertex. In embodiments where three grooves converge at a vertex, they are arrayed in a bifurcated pattern, meaning approach of the common vertex from any one of the grooves will diverge into two separate (hence bifurcated) paths away from the common vertex. In some embodiments described herein, the furcated EGFs form planform patterns of adjoining hexagons, which share a common groove and two vertices with neighboring adjoining hexagons. In some embodiments, the adjoining hexagons are outer hexagons, which respectively circumscribe other planform EGF patterns, such as hexagons, trapezoids, and/or triangles. In some embodiments, the furcated EGF planform pattern vertices are vertically aligned with engineered surface features (“ESFs”) that project upwardly from the component substrate surface.

The multifurcated EGFs isolate and localize thermos-mechanical stress—or foreign object damage (“FOD”)—induced crack propagation within the TBC layer, by spreading the stress forces in the OTBC layer adjoining one upstream groove to multiple downstream grooves across their common vertex. In some embodiments, the applied upstream thermo-mechanical stress is dissipated or attenuated by the downstream common vertex grooves. In other embodiments, the applied upstream thermo-mechanical stress is sufficiently high to fatigue crack the TBC or OTBC material that adjoins the downstream-furcated EGFs, until the stress is transferred to the next set of converging, furcated EGFs in the planform pattern. The transferred stress is in turn furcated in the next furcated EGFs, in cascading fashion. Crack formation is arrested when the furcated stress concentration diminishes sufficiently to be fully attenuated within a downstream zone of the TBC or OTBC material. In this manner, the furcated EGF pattern, with our without vertical alignment of ESFs projecting from the component substrate surface, enables the TBC or OTBC outer surface to self-absorb and dissipate induced thermo-mechanical stress in a minimized surface area. Thus, crack propagation and/or resultant spallation is also minimized on the TBC or OTBC outer surface.

### General Summary of Thermally Sprayed TBC

### Application in Combustion Turbine Engine Components

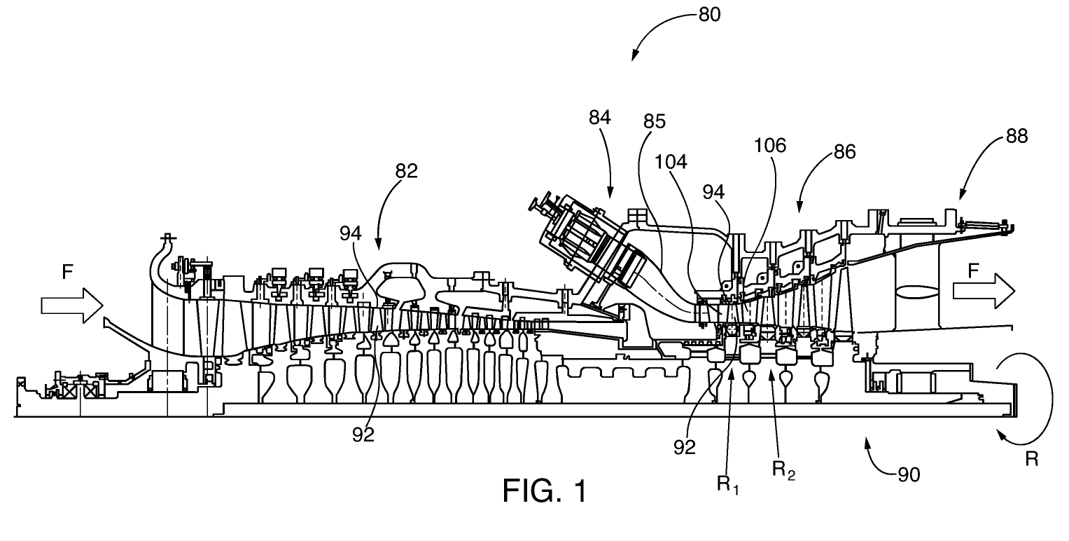

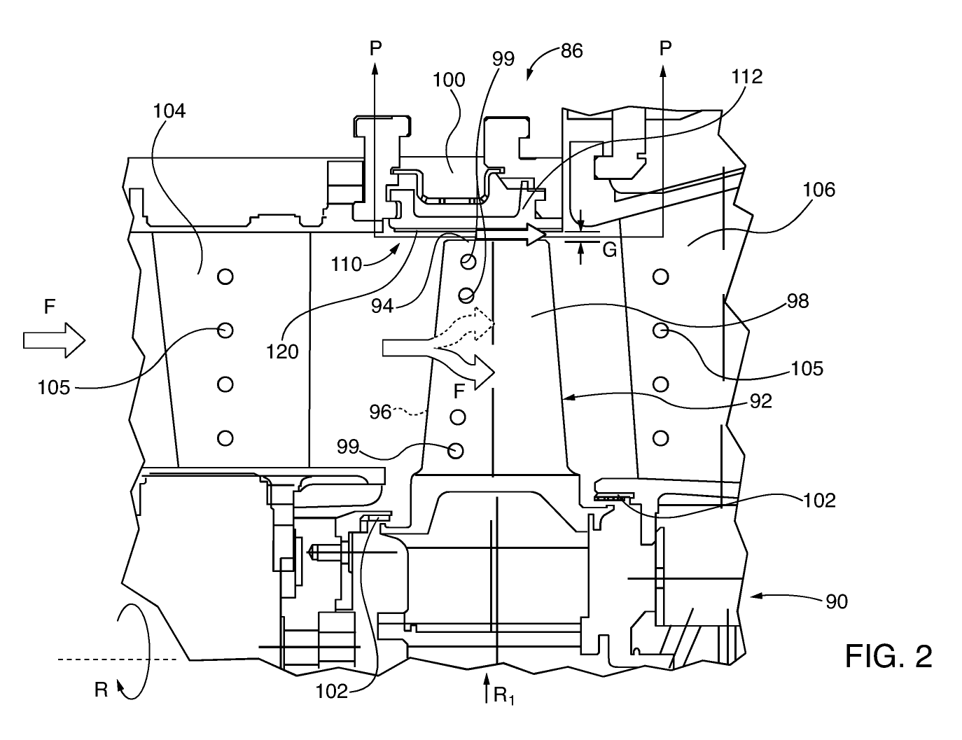

Referring to FIGS. 1-2, turbine engines, such as the gas or combustion turbine engine 80 include a multi-stage compressor section 82, a combustion section 84, a multi-stage turbine section 86 and an exhaust system 88. Atmospheric pressure intake air is drawn into the compressor section 82 generally in the direction of the flow arrows F along the axial length of the turbine engine 80. The intake air is progressively pressurized in the compressor section 82 by rows rotating compressor blades and directed by mating compressor vanes to the combustion section 84, where it is mixed with fuel and ignited. The ignited fuel/air mixture, now under greater pressure and velocity than the original intake air, is directed through a transition 85 to the sequential blade rows R₁, R₂, etc., in the turbine section 86. The engine's rotor and shaft 90 has a plurality of rows of airfoil cross sectional shaped turbine blades 92 terminating in distal blade tips 94 in the compressor 82 and turbine 86 sections.

For convenience and brevity further discussion of thermal barrier coat (“TBC”) layers on the engine components will focus on the turbine section 86 embodiments and applications, though similar constructions are applicable for the compressor 82 or combustion 84 sections, as well as for steam turbine engine components. In the engine's 80 turbine section 86, each turbine blade 92 has a concave profile high-pressure side 96 and a convex low-pressure side 98. Cooling holes 99 that are formed in the blade 92 facilitate passage of cooling fluid along the blade surface. The high velocity and pressure combustion gas, flowing in the combustion flow direction F imparts rotational motion on the blades 92, spinning the rotor 90. As is well known, some of the mechanical power imparted on the rotor shaft 90 is available for performing useful work. The combustion gasses are constrained radially distal the rotor 90 by turbine casing 100 and proximal the rotor 90 by air seals 102 comprising abradable surfaces.

Referring to the Row 1 section shown in FIG. 2, respective upstream vanes 104 and downstream vanes 106 respectively direct upstream combustion gas generally parallel to the incident angle of the leading edge of turbine blade 92 and redirect downstream combustion gas exiting the trailing edge of the blade 92 for a desired entry angle into downstream Row 2 turbine blades (not shown). Cooling holes 105 that are formed in the vanes 104, 106 facilitate passage of cooling fluid along the vane surface. It is noted that the cooling holes 99 and 105 shown in FIG. 2 are merely schematic representations, are enlarged for visual clarity, and are not drawn to scale. A typical turbine blade 92 or vane 104, 106 has many more cooling holes distributed about the respective airfoil bodies of much smaller diameter relative to the respective blade or vane total surface area that is exposed to the engine combustion gas.

As previously noted, turbine component surfaces that are exposed to combustion gasses are often constructed with a TBC layer for insulation of their underlying substrates. Typical TBC coated surfaces include the turbine blades 92, the vanes 104 and 106, ring segments 120, and related turbine vane carrier surfaces and combustion section transitions 85. The TBC layer for blade 92, vanes 104 and 106, ring segments 120, and transition 85 exposed surfaces are often applied by thermal sprayed or vapor deposition or solution/suspension plasma spray methods, with a total TBC layer thickness of 300-2000 microns (μm).

### Turbine Blade Tip Abradable Component TBC Application

Insulative layers of greater thickness than 1000 microns (μm) are often applied to sector shaped turbine blade tip abradable ring segment 110 components (hereafter also referred to generally as an “abradable component”) that line the turbine engine 80 turbine casing 100 in opposed relationship with the blade tips 94. The abradable components 110 have a support surface 112 retained within and coupled to the casing 100 and an insulative abradable substrate 120, which has an outer surface that is in opposed, spaced relationship with the blade tip 94 by a blade tip gap G. The abradable substrate 120 is often constructed of a metallic/ceramic material, similar to the TBC coating materials that are applied to blade 92, vanes 104, 106 and transition 85 combustion gas exposed surfaces. Those abradable substrate materials have high thermal and thermal erosion resistance and maintain structural integrity at high combustion temperatures. Generally, it should be understood that some form of TBC layer is formed over the blade tip abradable component 110 bare underlying metallic support surface substrate 112 for insulative protection, plus the insulative substrate thickness that projects at additional height over the TBC. Thus it should be understood that the ring segment abradable components 110 have a functionally equivalent TBC layer to the TBC layer applied over the turbine transition 85, blade 92 and vanes 104/106. The abradable surface 120 function is analogous to a shoe sole or heel that protects the abradable component support surface substrate 112 from wear and provides an additional layer of thermal protection. Exemplary materials used for blade tip abradable surface ridges/grooves include pyrochlore, cubic or partially stabilized yttria stabilized zirconia. As the abradable surface metallic ceramic materials is often more abrasive than the turbine blade tip 94 material a blade tip gap G is maintained to avoid contact between the two opposed components that might at best cause premature blade tip wear and in worse case circumstances might cause engine damage.

The ring segment abradable components 110 are often constructed with a metallic base layer support surface 112, to which is applied a thermally sprayed ceramic/metallic abradable substrate layer of many thousands of microns thickness( i.e., multiples of the typical transition 85 blade 92 or vanes 104/106 TBC layer thickness). As will be described in greater detail herein, the ring segment 120 abradable surface 120 planform and projection profile embodiments described in the related patent applications for which priority is claimed herein include grooves, depressions or ridges in the abradable substrate layer 120 to reduce abradable surface material cross section for potential blade tip 94 wear reduction and for directing combustion airflow in the gap region G. Commercial desire to enhance engine efficiency for fuel conservation has driven smaller blade tip gap G specifications: preferably no more than 2 millimeters and desirably approaching 1 millimeter (1000 μm).

### Engineered Surface Features (“ESFs”) Enhance TBC Adhesion and Crack Isolation

Some exemplary turbine component embodiments incorporate an anchoring layer of ESFs that aid mechanical interlocking of the TBC layer and aid in isolation of cracks in the TBC layer, so that they do not spread beyond the ESF. In some blade tip abradable applications the solid ridge and groove projecting surface features as well as micro surface features (“MSFs”) function as ESFs, depending upon the former's physical dimensions and relative spacing between them, but they are too large for more general application to turbine components other than blade tip abradable components. For exemplary turbine blade, vane or combustor transition applications the ESFs are formed in an anchoring layer that is coupled to an inner surface layer of the TBC layer and they are sized to anchor the TBC layer coating thickness range of 300-2000 microns (μm) applied to those components without changing an otherwise generally flat outer surface of the TBC layer that is exposed to combustion gas. Generally, the ESFs have heights and three-dimensional planform spacing on the turbine component surface sufficient to provide mechanical anchoring and crack isolation within the total thickness of the TBC layer. Thus, the ESFs will be shorter than the total TBC layer thickness but taller than etched or engraved surface features that are allegedly provided to enhance adhesion bonding between the TBC and the adjoining lower layer (e.g., an underlying naked substrate or intermediate BC layer interposed between the naked substrate and the TBC layer). Generally, in exemplary embodiments the ESFs have a projection height between approximately two to seventy-five percent (2-75%) of the TBC layer's total thickness. In some preferred embodiments, the ESFs have a projection height of at least approximately thirty-three percent (33%) of the TBC layer's total thickness. In some exemplary embodiments, the ESFs define an aggregate surface area at least twenty percent (20%) greater than an equivalent flat surface area.

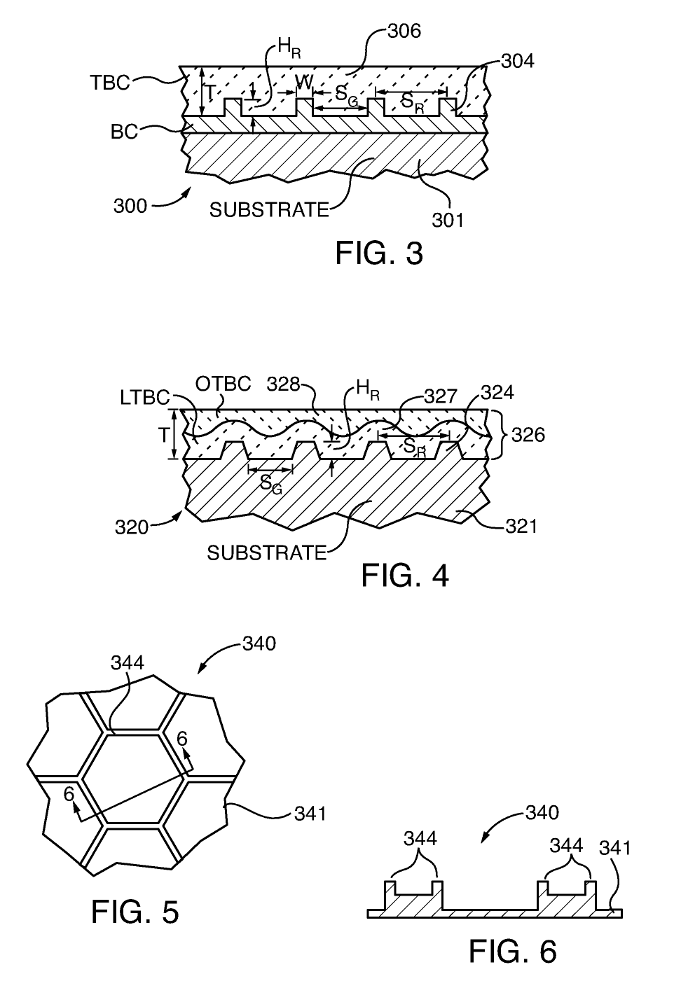

FIGS. 3 and 4 show exemplary embodiments of ESFs formed in an anchoring layer that is coupled to an inner surface of the TBC layer. The TBC layer 306/326 may comprise multiple layers of TBC material, but will ultimately have at least a TBC with an outer surface for exposure to combustion gas. In FIG. 3, the turbine component 300/320, for example a combustor section transition, a turbine blade or a turbine vane, has a metallic substrate 301 that is protected by an overlying TBC. A BC layer 302 is built upon and applied over the otherwise featureless substrate 301, which incorporates a planform pattern of ESFs 304. Those ESFs 304 are formed directly in the BC by: (i) known thermal spray of molten particles to build up the surface feature or (ii) known additive layer manufacturing build-up application of the surface feature, such as by 3-D printing, sintering, electron or laser beam deposition or (iii) known ablative removal of substrate material manufacturing processes, defining the feature by portions that were not removed. The ESFs 304 and the rest of the exposed surface of the BC layer 302 may receive further surface treatment, for example surface roughening, micro engraving or photo etching processes to enhance adhesion of the subsequent thermally sprayed TBC layer 306. Thus, the ESFs 304 and the remaining exposed surface of the BC layer 302 comprise an anchoring layer for the TBC layer 306. The outer surface of the TBC layer 306 is exposed to combustion gas.

In FIG. 4 turbine component 320 has an anchoring layer construction, where the planform array of ESFs 324 are formed directly in the otherwise featureless substrate 321, by known direct casting or build-up on the substrate surface by thermal spraying, additive layer build up or, alternatively, by known ablative or other mechanical removal of substrate material, manufacturing processes that defines the feature by remaining portions of the substrate that were not removed. The ESFs 324 and the exposed surface of the naked substrate 321 may receive further surface treatment, for example surface roughening, micro engraving or photo etching processes to enhance adhesion of the subsequent thermally sprayed TBC layer 326. Thus, the ESFs 324 and the naked substrate surface comprise an anchoring layer for the TBC layer 326 without any intermediate BC layer. A multi-layer TBC 326 is applied over the anchoring layer. The multi-layer TBC layer 326 comprises a lower thermal barrier coat (“LTBC”) 327 layer that is coupled to anchoring layer (in some embodiments the LTBC functions as a portion of the anchoring layer) and an outer thermal barrier coat (“OTBC”) layer 328 that has an outer surface for exposure to combustion gas. Additional TBC intermediate layers 326 may be applied between the LTBC layer 327 and the OTBC layer 328. In some embodiments, a multi-layer TBC layer is applied over any other type of ESFs that have been previously described. For example, while not shown in the figures, a variation of the construction of the turbine component 300 of FIG. 3, with the ESFs 304 formed in the BC layer 302, has a multi- layer TBC 306 similar to the TBC layer 326 applied over the ESFs 304.

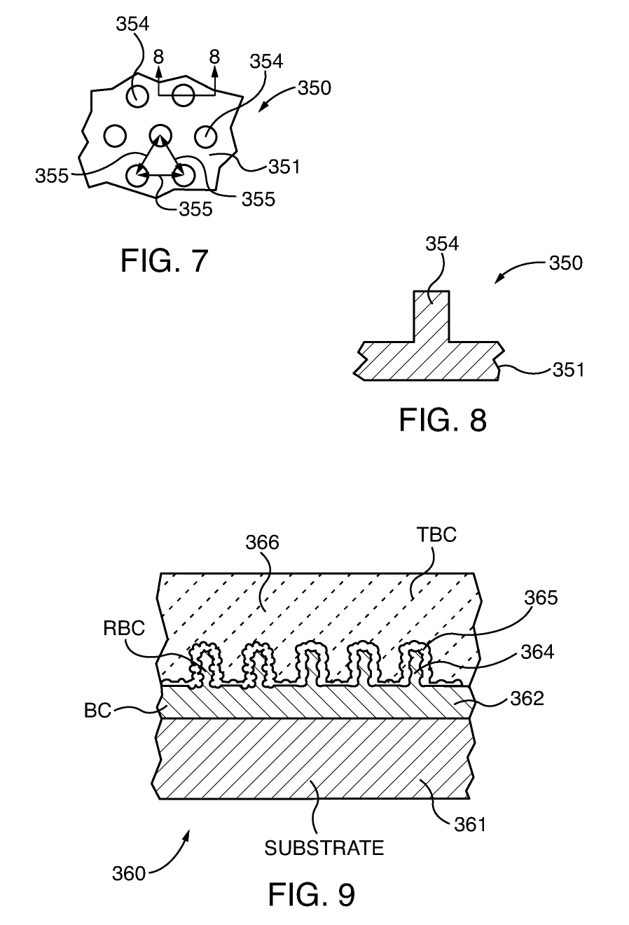

ESF cross sectional profiles, their planform array patterns, and their respective dimensions may be varied during design and manufacture of the turbine component to optimize thermal protection by inhibiting crack formation, crack propagation, and TBC layer spallation. Different exemplary permutations of ESF cross sectional profiles their three-dimensional planform array patterns and their respective dimensions are shown in FIGS. 5-9. In these figures ESF height, ESF ridge width, ridge spacing, and groove width between ridges are illustrated. In exemplary embodiments of FIGS. 5-9, the ESFs are selectively arrayed in three-dimensional planform linear or polygonal patterns. For example, the ESF planform pattern of parallel vertical projections shown in FIGS. 7 and 8 can also be repeated orthogonally or at a skewed angle in the plane projecting in and out of the drawing figures. In FIGS. 5 and 6, the turbine component 340 has, a metallic substrate 341 with ESFs 344 formed therein, comprising a hexagonal planform of dual grooves circumscribing an upper groove. In FIGS. 7 and 8, the turbine component 350 has, a metallic substrate 351 with ESFs 354 formed therein, comprising cylindrical pins. For visual simplicity of FIGS. 5-8, the turbine components 340 and 350 are shown without a TBC layer covering the ESFs 344 or 354. The ESFs 344 or 354 are generally repeated over at least a portion of the surface of their respective substrates. The spacing pitch and footprint size of the three-dimensional planform patterns can also be varied locally on the surface topology of the turbine component.

While the ESFs shown in FIGS. 5-8 are formed directly in their respective substrates, as previously discussed they may be formed in a BC that is applied over a featureless substrate. It is also noted that additional anchoring capability can be achieved by applying a rough bond coat (“RBC”) layer over the anchoring layer surface, such as the RBC layer 365 of the turbine component 360 shown in FIG. 9. While the RBC 365 is shown applied over the BC 362 and its ESFs 364, it or other types of BCs 362 can also be applied directly over the component metallic substrate 361.

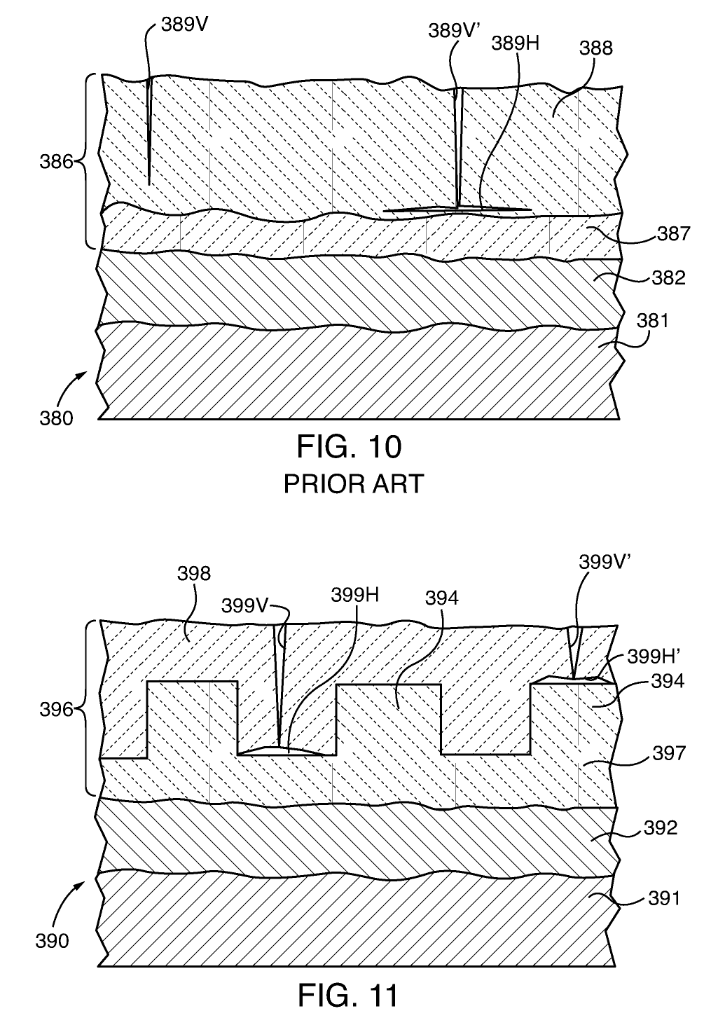

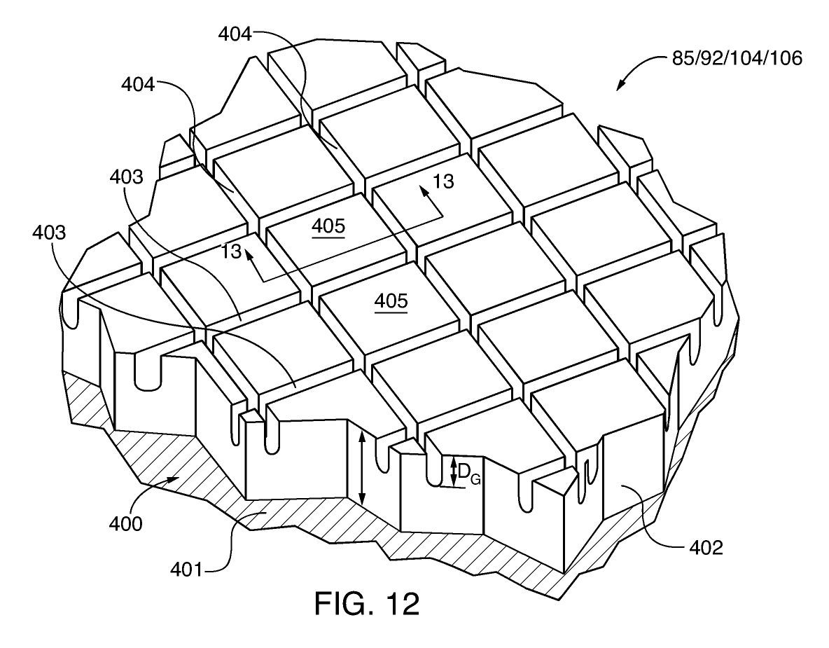

As previously mentioned, in addition to TBC layer-anchoring advantages provided by the ESFs described herein, they also localize TBC layer crack propagation. In the turbine component 380 of FIG. 10, thermally and/or foreign object induced cracks 389V and 389 H have formed in an outer TBC layer 388 of bi-layer TBC 386. The inner TBC layer 387, usually having different material properties than the outer TBC layer 388, is coupled to a BC layer 382, with the BC layer 382 in turn coupled to the component metallic substrate 381. The right-most vertical crack 389V′ has penetrated to the interface of the outer TBC 388 and inner 387 TBC layers and is now propagating horizontally as crack 389H. Further propagation of the crack 389H may cause delamination of the outer TBC layer 388 from the rest of the turbine component 380 and ultimately potential spallation of all outer TBC layer 388 material located between the right- and left-most vertical cracks 389V and 389V′. Spallation ultimately reduces overall thermal insulative protection for the underlying metallic substrate 381 below the spallation zone.

Now compare the crack propagation resistant construction of the turbine component 390 shown in FIG. 11. The metallic substrate 391 also has a BC over layer 382 to which is affixed a TBC layer 396. The TBC layer 396 further comprises a lower thermal barrier coating (“LTBC”) layer 397 that has ESFs 394 formed therein for interlocking with the outer thermal barrier coat (“OTBC”) layer 398. Thus, the LTBC layer 397 with its ESFs 394 effectively functions as the anchoring layer for the OTBC layer 398. In some embodiments, the LTBC layer 397 has greater strength and ductility material properties than the OTBC layer 398, while the latter has greater thermal resistivity and brittleness material properties. Vertical crack 399V has propagated through the entire thickness of the OTBC 398, but further vertical propagation has been arrested at the interface of the LTBC 397. While the vertical crack 399V has spread to form horizontal crack 399H along the OTBC/LTBC interface, the horizontal crack propagation is further arrested upon intersection with vertical walls of the ESFs 394 that flank the horizontal crack zone, so that potential delamination of the OTBC 398 is confined to the groove width between the ESFs 394. Should all or part of the OTBC layer 398 above the horizontal crack 399H spall from the remainder of the component the relatively small surface area of the now exposed LTBC 397 will better resist thermal damage potential to the underlying turbine component substrate 391. Similarly, vertical propagation of the vertical crack 399V′ is arrested upon intersection with the top ridge surface of the ESF 394 abutting that crack. Arresting further vertical penetration of the crack 399V′ reduces likelihood of OTBC 398 spallation around the crack.

### Engineered Groove Features (“EGFs”) Enhance TBC Crack Isolation

Some exemplary turbine component embodiments incorporate planform arrays of engineered groove features (“EGFs”), which are formed in the outer surface of the TBC after the TBC layer application. Groove depth and width are selectively varied. In some embodiments grooves cut into some or all thermal barrier coating layers, engineered surface features (ESFs), bond coat (BC) layers, or even into the underlying substrate surface. The EGFs groove axes are selectively oriented, at any skew angle relative to the TBC outer surface and extend into the TBC layer. Analogous to a firefighter fire line, the EGFs isolate cracks in the TBC layer, so that they do propagate across the boundary of a groove void into other portions of adjoining TBC material. Generally, if a crack in the TBC ultimately results in spallation of material above the crack the EGF array surrounding the crack forms a localized boundary perimeter of the spall site, leaving TBC material outside the boundary intact. Within the spallation zone bounded by the EGFs, damage will be generally limited to loss of material above the EGF groove depth. Thus in many exemplary embodiments EGF depth is limited to less than the total thickness of all TBC layers, so that a volume and depth of intact TBC material remains to provide thermal protection for the local underlying component metallic substrate. In some embodiments, the EGF arrays are combined with ESF arrays to provide additional TBC integrity than either might provide alone.

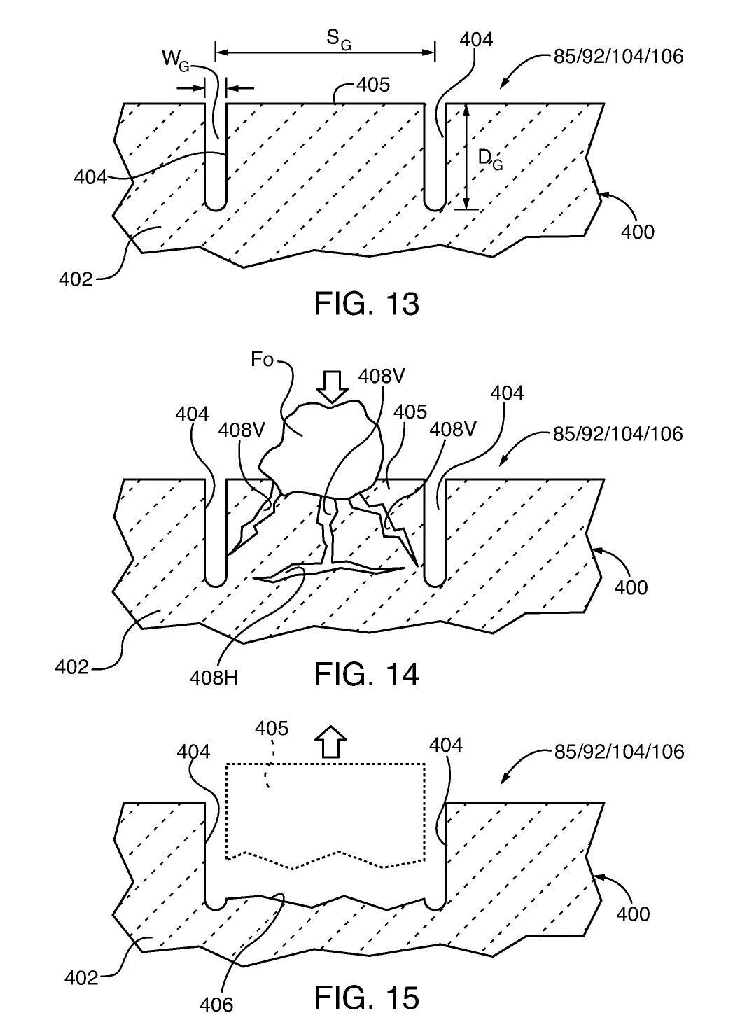

FIGS. 28 and 13 show a turbine component 400 having an underlying metallic substrate 401 onto which is affixed a TBC substrate 402 with an exemplary three-dimensional planform array of orthogonally intersecting engineered groove features EGFs 403, 404 that were formed after TBC layer application. The grooves 403 and 404 are constructed with one or more groove depths D_{G}, groove widths W_{G}, groove spacing S_{G}, and/or polygonal planform array pattern. Pluralities of any of different groove depth, spacing, width, and polygonal planform pattern can be varied locally about the turbine component 400 surface. For example, three-dimensional planform polygonal patterns can be repeated across all or portions of the component surface and groove depths may be varied across the surface. While the TBC layer 402 is shown as directly coupled to the substrate 401 intermediate anchoring layer constructions previously described can be substituted in other exemplary embodiments, including one or more of bond coat (“BC”) or lower thermal barrier coat layers (“LTBC”).

Exemplary engineered groove feature (“EGF”) crack isolation capabilities are shown in FIGS. 14 and 15, wherein a turbine component 400, such as a combustion section transition 85, a turbine blade 92, or a turbine vane 104/106 sustains foreign object (“FOD”) impact damage, resulting in vertical and horizontal cracks 408H and 408V within its TBC 402 outer surface 405. The EGFs 404 flanking the impact damage stop further crack propagation across the groove void, sparing TBC material outside the groove boundaries from further cascading crack propagation. Should the TBC material in the impact zone spall from the TBC outer surface 405, remaining intact and undamaged “pot hole” TBC layer 402 material bounded by the cracks and the cratered floor 406 protects the underlying metallic substrate 401 from further damage.

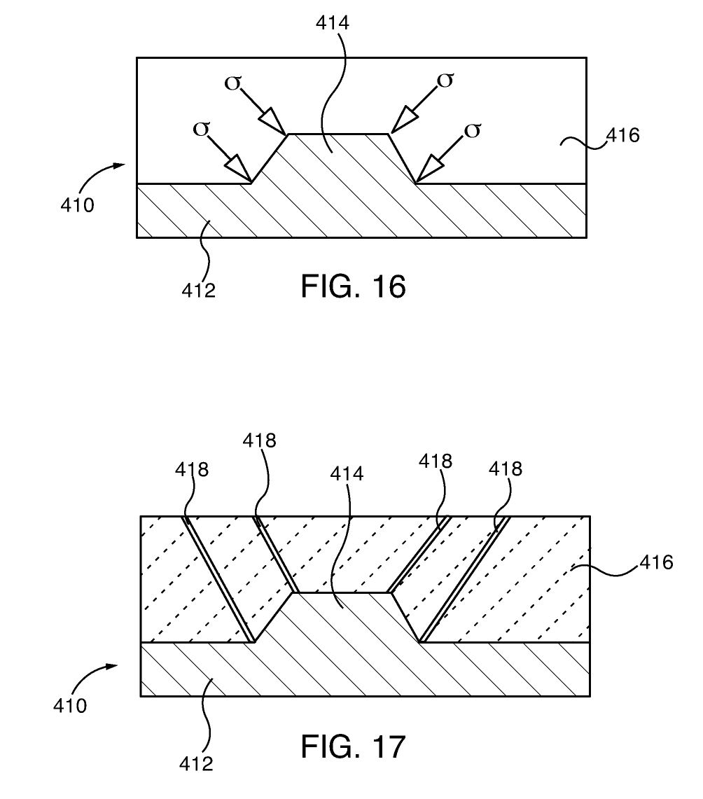

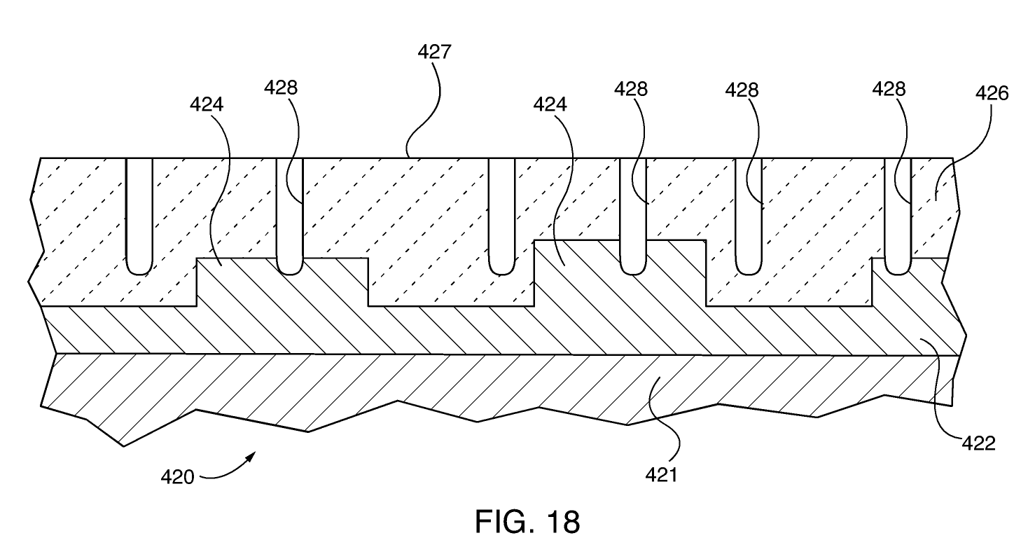

Unlike prior known TBC stress crack relief mechanisms that create voids or discontinuities within the applied thermally sprayed or vapor deposited TBC layer, such as by altering layer application orientation or material porosity, the engineered groove feature (“EGF”) embodiments herein form cut or ablated grooves or other voids through the previously formed TBC layer outer surface to a desired depth. As shown in FIGS. 16 and 17, the turbine component 410 has an anchoring layer 412 that includes trapezoidal cross sectional profile engineered surface features (“ESFs”) 414. The arrows in FIG. 17 identify likely sites in the TBC layer 416 for actual or potential thermal or mechanical stress concentration zones σ at the intersecting edges or vertices of the ESF 414 during turbine engine operation. Accordingly, EGFs 418 are cut at an angle along the stress line σ at a skewed groove axis angle into the TBC outer surface. The EGFs 418 are also cut at sufficient depth to intersect the ESF 414 vertices. Stresses induced in the TBC layer 416 on either side of the EGFs 418 do not propagate from one side to the other. The TBC layer 416 on either side of an EGF 418 is free to expand or contract along the groove void, further reducing likelihood of crack generation parallel to the groove.

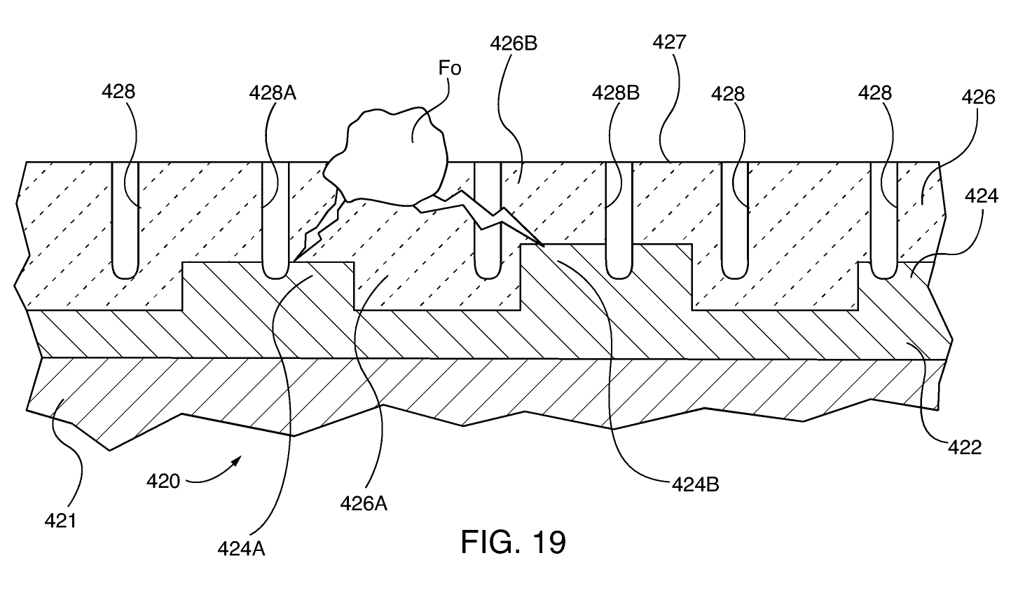

The turbine component embodiments of FIGS. 17-19 show additional TBC crack inhibition and isolation advantages afforded by combination of engineered groove features (“EGFs”) and engineered surface features (“ESFs”). In FIG. 16, the advantages of relieving actual or potential stress lines σ were achieved by forming the EGF 418 all the way through the TBC 416 depth until it intersected the anchoring layer's ESF 414. In the embodiment of FIGS. 18 and 19, the turbine component 420 (e.g., turbine blade or vane or transition) metallic substrate 421 has a bond coat (“BC”) 422 anchoring layer, which defines engineered surface features (“ESFs”) 424 that are oriented in a three-dimensional planform pattern. The TBC layer 426 is applied over the anchoring layer and after which another planform three-dimensional pattern of EGFs 428 are cut through the TBC layer outer surface 427 that is exposed to combustion gasses. The EGF 428 planform patterns may differ from the ESF 424 planform patterns. If the same planform pattern is used for both the ESFs and the EGFs, their respective patterns do not necessarily have to be vertically aligned within the TBC layer(s). In other words, the EGFs and ESFs may define separate three-dimensional, independently aligned planform patterns across the component. In some embodiments the ESFs and EGFs, respectively have repeating three-dimensional planform patterns. Patterns may vary locally about the component surface.

In FIG. 18, the EGF 428, planform pattern does not have any specific alignment that repetitively corresponds to the ESF 424 pattern. Some of the EGFs 428 is cut into the ESF 424 ridge plateaus and others only cut into the TBC 426 layer. In FIG. 19, a foreign object (“FO”) has impacted the TBC outer surface 427, creating cracks that are arrested by the ESFs 424A, 424B, and the EGFs 428A and 428B that bound or otherwise circumscribe the FO impact zone. Should the TBC material 426B that is above the cracks separate from the remainder of the turbine component 420 TBC layer, the remaining, non-damaged TBC material 426A that remains affixed to the BC anchoring layer 422 at the base of the “pot hole” provides thermal protection to its underlying metallic substrate 421.

### Engineered Groove Features (EGFs)

### Inhibit TBC Delamination Around Cooling Holes

Advantageously, engineered groove features (“EGFs”) can be formed in the TBC layer around part of or the entire periphery of turbine component cooling holes or other surface discontinuities, in order to limit delamination of the TBC over layer along the cooling hole or other discontinuity margins in the component substrate. The TBC layer at the extreme margin of the cooling hole can initiate separation from the metallic substrate that can spread laterally/horizontally within the TBC layer away from the hole. Creation of an EGF at a laterally spaced distance from the cooling hole margin—such as at a depth that contacts the anchoring layer or the metallic substrate—limits further delamination beyond the groove.

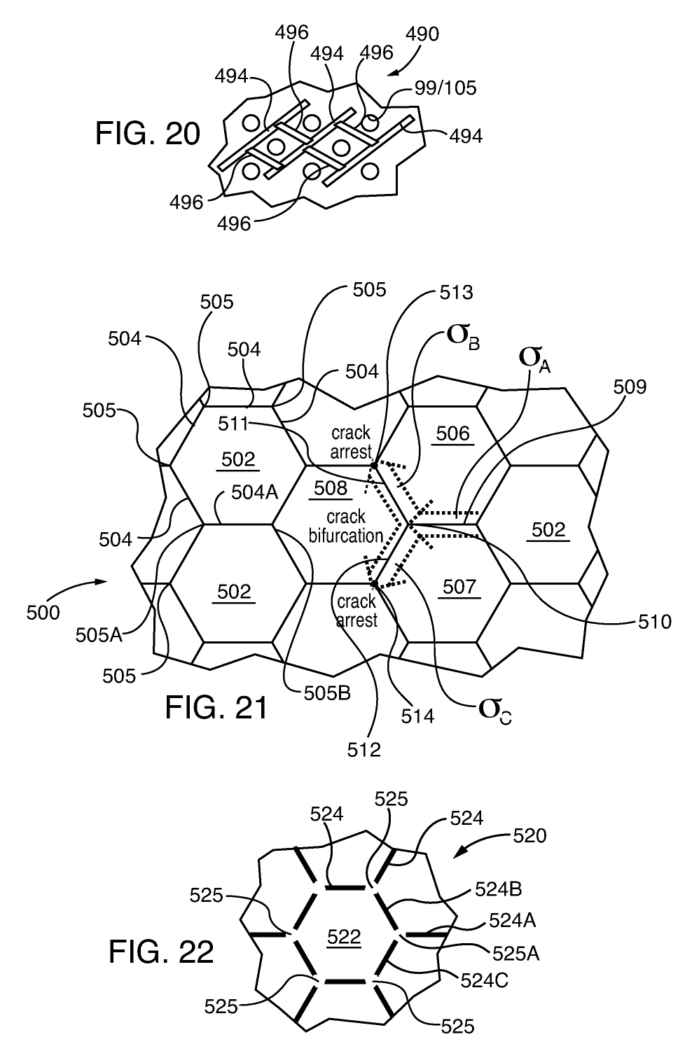

In FIG. 20, the turbine component 490, for example a turbine blade or a turbine vane, has a plurality of respective cooling holes 99/105 that are fully circumscribed by the linear EGF segments 494 and 496 of turbine component 490 fully or partially circumscribe cooling holes 99/105 from each other. TBC delamination along one or more of the cooling hole 99/105 peripheral margins is arrested at the intersection of the circumscribing EGF segments 494 and 496. For brevity, further description of hole periphery EGFs is limited to the groove shape and orientation. Underlying substrate, anchoring layer, ESF and any other EGFs are constructed in accordance with prior descriptions previously as described.

### Pattern Arrays of Engineered Groove Features (EGF)

### Furcate or Arrest Crack Propagation in Sequential, Cascading Fashion

The engineered groove feature (“EGF”) planform pattern embodiments of FIGS. 21-28 incorporate converging groove segments, at least three of which, in repetitive patterns, share a common vertex. In relative geometric terms, each groove terminus at its common vertex furcates, or branches out to at least two other diverging grooves, which is analogous to an upstream water stream splitting into two downstream tributary streams. In a bifurcating water stream, the flow volume is divided between the two downstream tributaries. The downstream flow volume in either tributary is less than the upstream flow volume. By analogy, the furcated EGF embodiments furcate, or divide upstream stress applied to the TBC or OTBC localized material along an upstream formed groove among the number of downstream grooves localized material. Localized downstream material in the TBC or OTBC absorbs the induced, now bifurcated, or reduced applied stress that crossed the common vertex boundary. If the downstream-localized material has sufficient strength to avoid cracking, any upstream cracking is thereby arrested. If the downstream-localized material cracks, the applied stress (and possibly the crack) propagates in cascading fashion to the next one or more common vertices. Cascading propagation continues until stress is reduced sufficiently to arrest further crack formation.

FIG. 21 is illustrative of an exemplary embodiment of furcated, engineered groove features (“EGFs”) in the TBC outer surface of a turbine blade, vane, or transition component 500. The EGFs form a hexagonal- or honeycomb-shaped planform pattern of adjoining hexagons 502, respectively having six grooves 504, which terminate in six vertices 505. Each pair of adjoining hexagons 502 shares a common groove segment 504A and a pair of two vertices 505A, 505B. Each shared common vertex 505 has three converging groove segments 504. In symmetrical hexagons, the trio of grooves 504 at each shared vertex 505 is oriented at 120 degrees. It follows that at each shared vertex (see, e.g., vertex 510), the three converging grooves (see, e.g., grooves 509, 511 and 512) respectively bifurcate into the other two adjoining grooves (see, e.g., groove 509 bifurcating into grooves 511 and 512). In other words, if one travels a path along one of the converging grooves towards the vertex, there is a subsequent bifurcated split into two downstream grooves.

The bifurcated, or in some embodiments multifurcated, groove geometry concept of FIG. 21 is useful for arresting crack propagation in the OTBC or TBC outer surface, whether the crack inducing stress in the TBC is caused by thermo-mechanical stress, induced by heating transients, or foreign object damage (“FOD”) impact mechanical stress. Referring to FIG. 21, crack-inducing stress σ_{A} initiated within the boundaries of the hexagons 506 and 507 will either be dissipated by the TBC material volume within those hexagons (i.e., arrested therein), or the stress-induced crack in the TBC material will eventually intersect one or more of the groove segments 511, 512 in the circumscribing hexagonal boundary of hexagon 508. If the stress σ_{A} propagates within any groove, such as groove 509, it will be either (i) arrested in its entirety before reaching a boundary vertex 510 or (ii) continue propagation σ_{B} and σ_{C} into the two adjoining downstream groove segments 511 and 512 that share the common vertex 510. When the stress σ_{A} propagates to two adjoining downstream groove segments 511, 512, the stress is bifurcated by some ratio, so that the resultant absolute stress level σ_{B} and σ_{C} in each adjoining hexagon (here hexagon 508) bounded by the respective downstream groove segments 511, 512 is lower than the absolute stress level σ_{A} in the upstream, transferring hexagons 506 and 507. As stress concentration is sequentially bifurcated (or multifurcated, in the case of more than two downstream groove segments) in cascading fashion, spreading the stress in controlled fashion over a larger surface area of the turbine component's outer thermal barrier coating (“OTBC”), it eventually reduces to a level that can be absorbed by the localized TBC layer. If localized stress within any one or more of the honeycomb, hexagonal planform patterns 502 of EGFs is sufficient to generate a crack, adjoining honeycomb EGF segments at the cascading vertices 505 will furcate the stress, until crack propagation is arrested. At each vertex 505, there is localized spreading of the stress to other downstream groove segments, or localized arrest/relaxation of the stress in a self-organized pattern.

As shown in the hexagonal planform pattern embodiment 522 of FIG. 22, the EGF groove segments 524 forming the hexagonal planform pattern are discontinuous, and do not converge into a commonly-communicating groove at each vertex 525, unlike the continuously communicating grooves 504 of the hexagonal planform pattern 502 FIG. 21. In some laser ablation or water jet cutting groove formation cutting processes, it is easier to form discontinuous grooves. When crack-inducing stress reaches termination of a discontinuous groove, such as the groove 524A, the crack will self-propagate across the solid TBC material at the local vertex 525A and bifurcate into the adjoining downstream grooves 524B and 524C. In other words, under thermo-mechanical stresses, the crack growth will effectively join the discontinuous groove segments into commonly communicating segments, as if they were originally so formed. The discontinuous EGF groove segment construction shown in FIG. 22 may be incorporated into any of the EGF embodiments shown and described in connection with any of the other figures herein, including the embodiments of FIGS. 21 and 23-28.

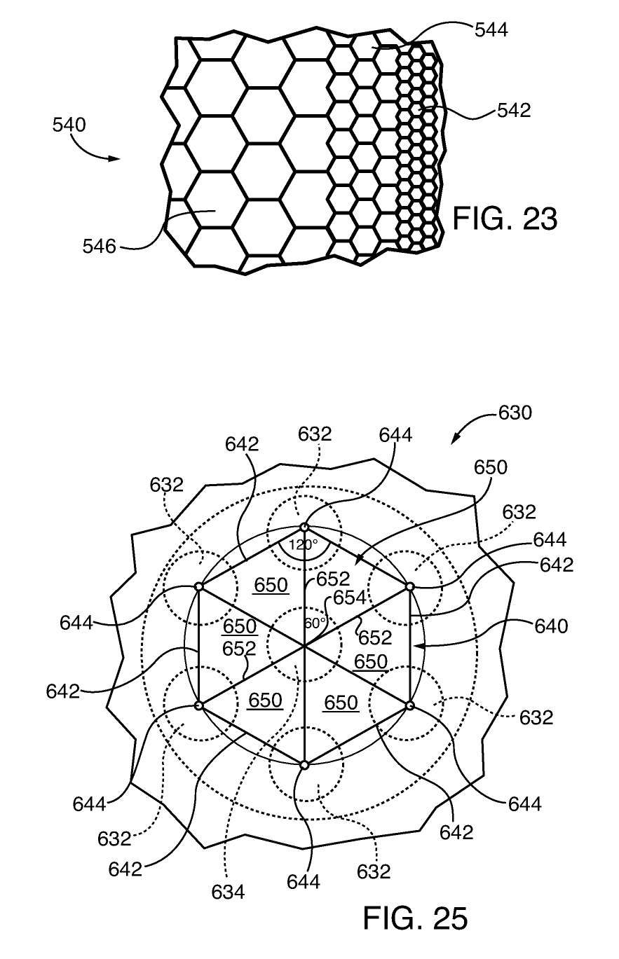

In FIG. 23, the adjoining hexagonal honeycomb patterns have different size and pitch density in different surface regions of the blade, vane, ring segment or transition component 540 TBC or OTBC coating outer surface. The optimal length scale for the suggested structures will depend on the TBC system (i.e., base material, bond coat, and TBC layers), the local temperature differences during the engine operating cycle, and the local topography of the component. Hence, in different regions of the surface of the component, the localized pitch and density pattern is optimized for its intended operating conditions. For example, distance between the hexagonal vertices and their converging groove segments might be larger in the blade root or blade platform portions of a turbine blade, as compared to distance on the blade's leading edge. EGF pitch and density are locally tailored to topographic differences, localized thermal stresses, and risk of foreign object damage (“FOD”). Focusing on blade leading edge operating conditions, its relatively large curvature, high exposure to combustion gasses and foreign objects entrained in the combustion gas, and combustion contaminant degradation of the TBC favors higher density, smaller honeycomb patterns, such as those of the rightmost planform pattern 542 in FIG. 23, whereas the blade pressure side surface might favor the intermediate size honeycomb pattern 544 in the central portion of that figure. The relatively larger honeycomb pattern 546 on the leftmost side of FIG. 23 might be suitable for the blade suction side surface and blade platform.

EGF groove cross sectional depth and width can be selectively varied locally in different surface regions of the blade, vane, or transition component 550 TBC or OTBC coating outer surface, in order to control stress and crack propagation, as shown in FIG. 24. Polygonal planform patterns are included within the circumscribing hexagons, for further localized crack propagation control. Here, the outer hexagon 560 in the continuous planform pattern circumscribes two nested hexagons: intermediate hexagon 570 and inner hexagon 580. The regions between the respectively nested hexagons 560, 570, 580 are filled with triangular sub regions in the shape of the triangles 590, 600, 610, with each triangle vertex having at least three converging groove segments. Triangle 590 comprises groove segments 592 and common vertices 594. The groove segments 592 that adjoin the outer hexagon 560 are co-extensive with portions of the groove segments 562, while in some locations the common vertices 564 and 594 are co-extensive. Similarly, the groove segments 592 that adjoin the intermediate hexagon 570 are co-extensive with portions of the groove segments 572, while in some locations the common vertices 574 and 594 are co-extensive. Moving inwardly within the nested hexagonal patterns, the triangle 600 has three groove segments 602 and common vertices 604. In some locations, the groove segments 602 are co-extensive with adjoining groove segments 572 or 582, which form the respective intermediate hexagons 570 and inner hexagons 580, and the common vertices 604 are in some locations co-extensive with the common vertices 574 or 584. With the nested hexagon and triangle furcated groove pattern of the TBC or OTBC outer surface 550, a stress concentration leading to crack formation distributes the stress constrained by the exemplary triangle 610 region to one or more of the vertices 614 or 584. Those vertices have respective downstream-furcated groove segments that form other adjoining triangles 610 or the inner hexagon 580. The crack-inducing stress dissipates as it cascades through the OTBC material downstream of each cascading, successive groove segment 612 or 582. If the crack in any one or more of the triangle 610 or hexagon 580 polygons is sufficient to cause a localized surface spalling, the spallation surface damage is minimized and constrained by the remaining, undamaged adjoining polygons, such as the triangles 600.

Generally, individual grooves forming the cascading EGFs have any desired groove dimensions or planform patterns, as previously described herein. As shown in FIG. 24, the outer hexagons 560 have wider and/or deeper grooves 562 than the inner circumscribed polygons 570, 580, 590 600, or 610. In FIG. 24, the intermediate hexagon grooves 572 are narrower and/or shallower than the grooves 562, while the grooves 582 are in turn narrower and/or shallower than the grooves 572. In some embodiments, any of the grooves 592, 602 and/or 612 in adjoining triangles, which are intermediate and skewed relative to the nested hexagon grooves 562, 572 and/or 582 are shallower and or narrower than those of the aforementioned hexagon grooves. Any of the aforementioned furcated grooves are formed by any manufacturing method previously described herein. The more groove segments that converge at each vertex furcates the upstream stress forces proportionately to the number of those segments. In this way, the stress force transferred to any of the downstream, multifurcated groove segment-bounded OTBC material is lower than the transferred stress force in the upstream, transferring groove segment-bounded OTBC material.

### Composite, Vertically Aligned Engineered Surface Features (ESF)

### And Engineered Groove Features (EGF)

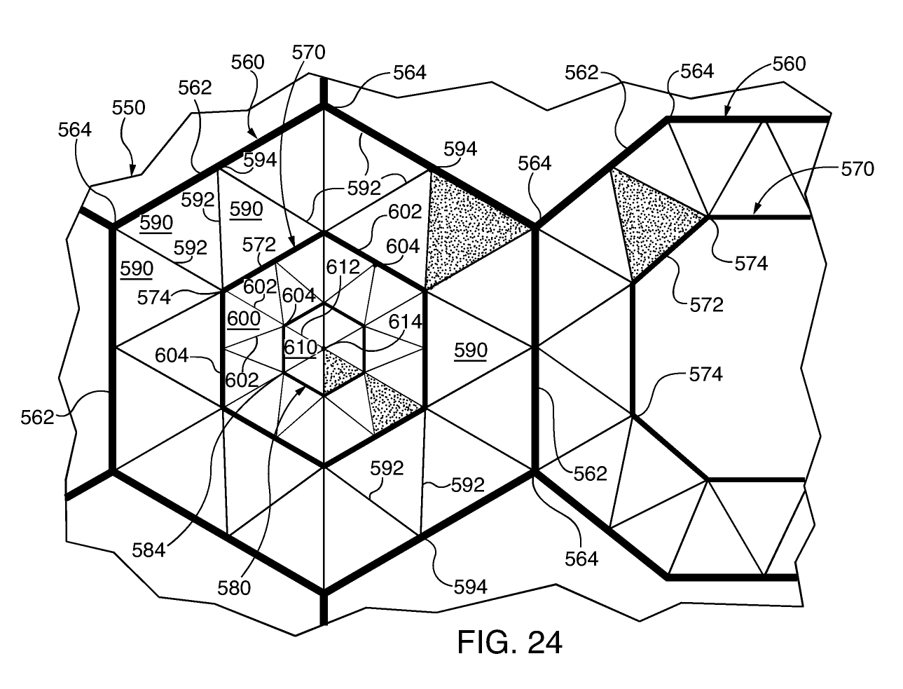

In some embodiments, such as in FIG. 25, thermal barrier coated (“TBC”) blades, vanes, ring segment abradable surfaces, or combustion gas transition components 630 have composite, vertically aligned engineered surface features (“ESFs”) 632, 634 and engineered groove features (“EGFs”) 642, 652, which combine the coating anchoring enhancement properties of the ESFs with the “firewall” and “pot hole” controlled spallation properties of the EGFs. As shown previously in FIG. 19, ESFs 424A and 424B, bounding a spalled “pothole” enhances anchoring of the remnant OTBC material 426A in the “pothole”. Returning to FIG. 25, the ESFs 632, 634 are constructed in any desired density, cross section footprint, or height, as previously described. In the embodiment of FIG. 25, a plurality of cylindrical shaped ESFs 632 (having circular cross sections) aligns with vertices 644 of overlying outer hexagon planform pattern 640 EGF groove segments 642. The ESFs 632 have similar construction to the ESFs 354 of FIGS. 7 and 8. Alternatively, the ESFs are formed in a hexagonal pattern as the ESFs 344 of FIGS. 5 and 6.

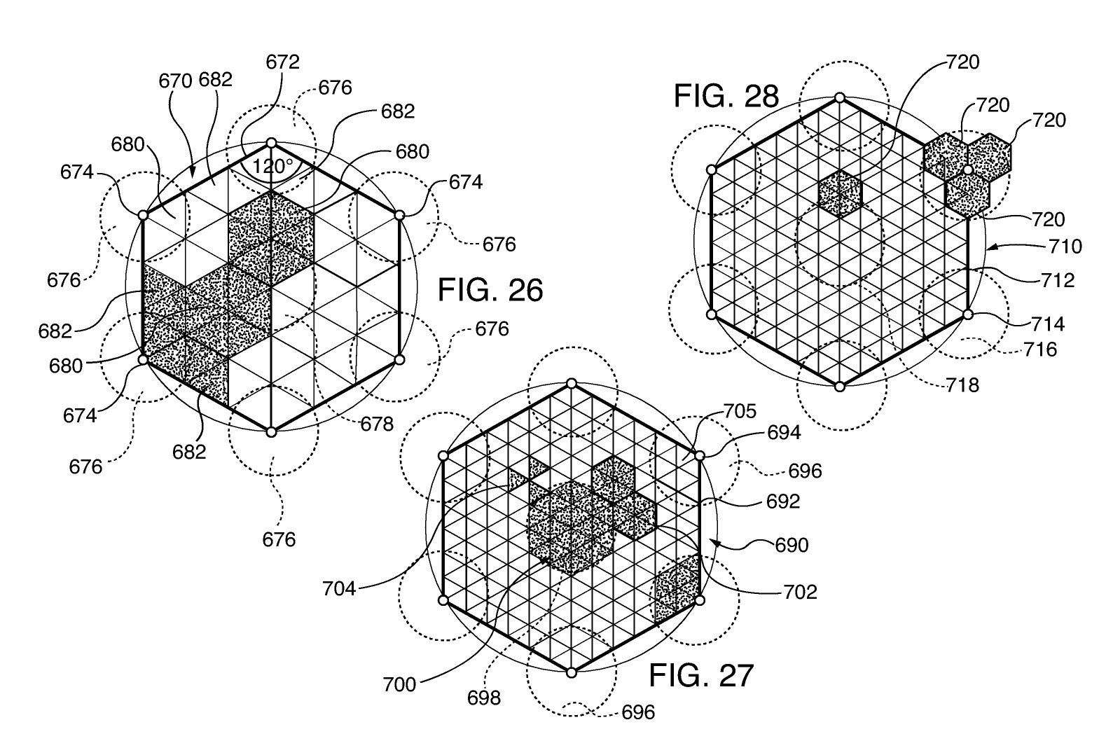

In the embodiment of FIGS. 26-28, the respective turbine vane, blade, ring segment abradable surface, or combustion gas transition component has a planform pattern of adjoining, respective outer hexagons 670, or 690, or 710, whose respective vertices 674, or 694, or 714 are oriented in vertical alignment within the planform of the respective cylindrical EGF 676, or 696, or 716 footprints. There is also a central ESF 678, 698, or 718 in each respective ESF planform pattern. In FIGS. 26-28 patterns of smaller polygonal hexagons 680, 700, or 702, or 720; half-hexagon-shaped trapezoids 682, or one-third-hexagon-shaped trapezoids 705; or triangles 704 are circumscribed by the respective outer hexagons 670, or 690, or 710. Spallation of any of the smaller polygons leaves the remaining smaller polygons covering and protecting the component. In FIG. 27, where higher density, smaller individual surface area polygons are desired, the smaller polygons are combinations of hexagons 700, 702, triangles 704, and trapezoids 705 that are circumscribed by the larger outer hexagon 690. In some embodiments, the larger circumscribing outer hexagons 640, 670, 690 and/or 710 of FIGS. 25-28 adjoin other similarly sized hexagons, or they abut against smaller hexagons, as in the planform local pattern of FIG. 23. Alternatively, the planform patterns of FIGS. 25-28 are discontinuous clusters of the outer hexagons that are arrayed in uniform or varying pitch and size patterns, or individual stand-alone outer hexagons 640, 670, 690, and/or 710.

More particularly, the furcated groove EGF patterns of FIGS. 25-28 further define within each outer hexagon a planform pattern of adjoining inner polygons. Adjoining inner polygons respectively share at least one common inner polygonal vertex, and each is respectively fully circumscribed within a corresponding respective outer hexagon 670, 690, or 710. Moreover, at least three respective furcated groove segments within the EGF pattern converge at each respective outer hexagonal or inner polygonal vertex in a bifurcated pattern, so that each converging groove segment has at least two other adjoining converging groove segments. A larger number of converging grooves in the planform pattern increases furcation of the transferred stress forces. By combining ESFs and EGFs it is more likely, that spallation will leave a crater of “pot hole” with remnant TBC material protecting the underlying substrate surface, despite spallation of the outermost material surface, as in FIG. 19. The higher density patterns of polygons circumscribed by hexagons of FIGS. 25-28 embodiments are suitable for leading edges of turbine blades and vanes.

In some embodiments, the larger hexagon EGFs with or without underlying, vertically aligned ESFs circumscribe thermal or mechanical stress concentration zones within the outer thermal barrier coating (“OTBC”), such as around cooling holes, analogous to the cooling hole groove embodiment of FIG. 20. In some embodiments, the EGFs have a skewed groove axis, analogous to the grooves 418 of FIG. 17.

### Cascading Engineered Groove Features (EGFs)

### Progressively Dissipate Stress in the TBC Layer

The cascaded planform patterns of the multifurcated EGFs of FIGS. 21-28, with or without underlying ESFs, control crack propagation in a thermal barrier coating outer layer of a blade, vane, transition or other component of an operating combustion turbine engine that is exposed to the turbine engine hot working fluid. During engine operation, thermal or mechanical stress is induced in the outer surface of the TBC or OTBC layer, which for example is a result of engine thermal cycling or by foreign object (“FO”) impact. When any of the induced stress forces are sufficiently high to fatigue the TBC or OTBC material and generate a crack within one or more of the inner polygons, the stress is attenuated and dissipated at each successive adjoining polygon as the stress force is furcated successively at each groove juncture vertex. Further crack propagation is arrested within one or more of successive inner polygons through which the crack propagates at its intersection with one or more of the groove segments defining the respective polygon, or upon its intersection with one or more of the groove segments defining a circumscribing hexagon. The crack propagates to other adjoining, circumscribing hexagons, if the crack is not arrested in the initially damaged hexagon. Progressive crack propagation through a vertex, into downstream, multifurcated groove segments, dissipates and attenuates localized stress. A crack is arrested once the propagating stress force is below fatigue strength of the local TBC or OTBC material. As a result, crack damage in the thermal barrier coating (“TBC”) is localized to the smallest surface area defined by the planform of furcated EGFs in the outer surface of the OTBC layer. If the crack causes OTBC surface spallation, remnant TBC material below the crack provides protection for the turbine component underlying substrate. Combination of the vertically aligned EGFs and ESFs enhances retention of the remnant TBC material below the crack, as previously described herein.

### Material Varying Multi-Layer and Graded TBC Construction

As was previously discussed, the aggregate thermally sprayed TBC layer of any turbine component embodiment described herein may have different local material properties laterally across the component surface or within the TBC layer thickness dimension. As one example, one or more separately applied TBC layers closest to the anchoring layer may have greater strength, ductility, toughness and elastic modulus material properties than layers closer to the component outer surface but the higher level layers may have greater thermal resistivity and brittleness material properties. A multi-layer TBC embodiment 326 is shown in FIG. 4. Alternatively, a graded TBC layer construction can be formed by selectively varying constituent materials used to form the TBC layer during a continuous thermal spraying process. In some embodiments, a calcium-magnesium-alumino-silicate (“CMAS”), or other contaminant deposit-resistant layer, is applied over TBC outer surface, for inhibiting adhesion of contaminant deposits to the TBC outer surface. Undesirable contaminant deposits can alter material properties of the TBC layer and decrease aerodynamic boundary conditions along the component surface. In embodiments where a CMAS-resistant layer is applied over and infiltrates EGF grooves that are formed in the TBC outer surface layer it enhances aerodynamic boundary conditions by forming a relatively smoother TBC outer surface and inhibits debris accumulation within the grooves.

Exemplary material compositions for thermal barrier coat (“TBC”) layers include yttria-stabilized zirconia, rare-earth stabilized zirconia with a pyrochlore structure, rare-earth stabilized fully stabilized cubic structure, or complex oxide crystal structures such as magnetoplumbite or perovskite or defective crystal structures. Other exemplary TBC material compositions include multi-element-doped oxides with high defect concentrations. Examples of CMAS retardant compositions include alumina, yttrium aluminum oxide garnet, slurry deposited/infiltrated highly porous TBC materials (the same materials that are utilized for OTBC or LTBC compositions), and porous aluminum oxidized to form porous alumina.

Although various embodiments that incorporate the teachings of the invention have been shown and described in detail herein, those skilled in the art can readily devise many other varied embodiments that still incorporate these teachings. The invention is not limited in its application to the exemplary embodiment details of construction and the arrangement of components set forth in the description or illustrated in the drawings. The invention is capable of other embodiments and of being practiced or of being carried out in various ways. For example, various ridge and groove profiles may be incorporated in different planform arrays that also may be locally varied about a circumference of a particular engine application. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. The terms “mounted”, “connected”, “supported”, and “coupled” and variations thereof encompass direct and indirect mountings, connections, supports, and couplings. Each term is intended to be used broadly. Further, “connected” and “coupled” are not restricted to physical or mechanical connections or couplings.

What is claimed is:

1. A combustion turbine engine blade, vane, transition, or ring segment abradable component having a heat insulating outer surface for exposure to combustion gas, comprising:
a metallic substrate having a substrate surface;
an anchoring layer built upon the substrate surface;
a thermally sprayed or vapor deposited or solution/suspension plasma sprayed, single- or multi-layer thermal barrier coat (TBC) having a TBC inner surface applied over and coupled to the anchoring layer and a TBC outer surface for exposure to combustion gas; and
a planform pattern of engineered groove features (EGFs) cut and formed into the TBC outer surface, and penetrating the previously applied TBC layer, having a groove depth,
the EGF pattern defining a planform pattern of adjoining outer hexagons respectively having six hexagonal vertices, with each respective pair of adjoining outer hexagons sharing a common groove segment,
the EGF pattern further defining within each outer hexagon a planform pattern of adjoining inner polygons, the adjoining inner polygons respectively sharing at least a common inner polygonal vertex and respectively fully circumscribed within its respective outer hexagon,
at least three respective groove segments within the EGF pattern converging at each respective outer hexagonal or inner polygonal vertex in a multifurcated pattern, so that each converging groove segment has at least two other adjoining converging groove segments.

2. The component of claim 1, further comprising:
a planform pattern of engineered surface features (ESFs) in and projecting from the anchoring layer; and
the EGF outer hexagonal vertices in vertical alignment with an underlying corresponding ESF.

3. The component of claim 1, further comprising the EGFs having a plurality of groove depths and/or widths through the TBC outer surface.

4. The component of claim 3, further comprising the outer hexagon groove segments having deeper groove depth and/or wider groove width than the inner polygon groove segments.

5. The component of claim 1, further comprising the EGF outer hexagons having a repeating three-dimensional planform pattern across at least a portion of the TBC outer surface, with locally varying pattern density and outer hexagon dimensions.

6. The component of claim 5 comprising a turbine engine blade or vane, the inner polygon pattern density higher along a respective leading edge thereof.

7. The component of claim 1, the EGF outer hexagons circumscribing a thermal, or a mechanical stress concentration zone in the TBC.

8. The component of claim 7, at least some of the inner polygons surrounding a thermal or a mechanical stress concentration zone in the TBC.

9. The component of claim 1, the planform pattern of adjoining inner polygons comprising adjoining triangular and/or hexagonal and/or trapezoidal groove segment patterns converging at polygonal vertices.

10. The component of claim 1, further comprising at least some converging EGF groove segments in direct communication with each other, forming a continuous groove.

11. The component of claim 1, at least some of the EGF groove segments further comprising discontinuous groove segments converging at a corresponding hexagonal or polygonal vertex, but not touching each other at said vertex.

12. The component of claim 1, further comprising at least some of the EGFs having a groove axis skewed relative to the TBC outer surface.

13. The component of claim 1, at least one inner polygon fully circumscribing another inner polygon.

14. A combustion turbine engine comprising the component of claim 1, the TBC layer portion outer surface in communication with a combustion path of the engine for exposure to combustion gas.

15. A method for controlling crack propagation in a thermal barrier coating (TBC) outer layer of an operating combustion turbine engine blade, vane, transition, or ring segment abradable component having a heat insulating outer surface for exposure to combustion gas, comprising:
providing a combustion turbine engine, the engine having a blade, vane, transition, or ring segment abradable component having:
a metallic substrate having a substrate surface;
an anchoring layer built upon the substrate surface;
a thermally sprayed or vapor deposited or solution/suspension plasma sprayed, single- or multi-layer thermal barrier coat (TBC) having a TBC inner surface applied over and coupled to the anchoring layer and a TBC outer surface for exposure to combustion gas; and
a planform pattern of engineered groove features (EGFs) cut and formed into the TBC outer surface, and penetrating the previously applied TBC layer, having a groove depth,
the EGF pattern defining a planform pattern of adjoining outer hexagons respectively having six hexagonal vertices, with each respective pair of adjoining outer hexagons sharing a common groove segment,
the EGF pattern further defining within each outer hexagon a planform pattern of adjoining inner polygons, the adjoining inner polygons respectively sharing at least a common inner polygonal vertex and respectively fully circumscribed within its respective outer hexagon,
at least three respective groove segments within the EGF pattern converging at each respective outer hexagonal or inner polygonal vertex in a multifurcated pattern, so that each converging groove segment has at least two other adjoining converging groove segments;
operating the engine, inducing thermal or mechanical stress in the TBC during engine thermal cycling or inducing mechanical stress in the TBC by foreign object impact, any of the induced stresses generating a crack in the TBC within one or more of the inner polygons; and
arresting further propagation of the crack within one or more of successive inner polygons through which the crack propagates at its intersection with one or more of the groove segments defining the respective polygon, or upon its intersection with one or more of the groove segments defining an adjoining polygon or upon its intersection with one or more of the groove segments defining a circumscribing outer hexagon.

16. The method of claim 15, further comprising arresting further crack propagation within another of the adjoining outer hexagons, if said propagation was not arrested within the previous circumscribing outer hexagon.

17. The method of claim 15, further comprising providing an EGF planform pattern of fully circumscribing nested polygons that are in turn nested within a circumscribing outer hexagon, crack propagation being fully arrested within one of the successive outwardly circumscribing inner polygons or its circumscribing hexagon, or one of the successive adjoining circumscribing hexagons.

18. The method of claim 17, further comprising separating a portion of the TBC layer between the component outer surface and the crack from the component, leaving an intact portion of the TBC layer on the substrate.

19. The method of claim 15, further comprising separating a portion of the TBC layer between the component outer surface and the crack from the component, leaving an intact portion of the TBC layer on the substrate.

20. The method of claim 15, the provided planform pattern of adjoining inner polygons comprising adjoining triangular and/or hexagonal and/or trapezoidal multifurcated groove segment patterns converging at polygonal vertices.
